(19) United States
(12) Patent Application Publication
(10) Pub. No.: US 2023/0090018 A1
(43) Pub. Date: Mar. 23, 2023

(54) MULTIMODE INTERFEROMETRIC DEVICE AND METHOD

(71) Applicants: Caroline BOUDOUX, Montréal (CA); Martin POINSINET DE SIVRY, Montréal (CA); Simon BOLDUC BEAUDOIN, Sherbrooke (CA); Nicolas GODBOUT, Verdun (CA)

(72) Inventors: Caroline BOUDOUX, Montréal (CA); Martin POINSINET DE SIVRY, Montréal (CA); Simon BOLDUC BEAUDOIN, Sherbrooke (CA); Nicolas GODBOUT, Verdun (CA)

(21) Appl. No.: 17/795,320

(22) PCT Filed: Jan. 27, 2021
(86) PCT No.: PCT/CA2021/050080

§ 371 Date: Jul. 26, 2022

Related U.S. Application Data
(60) Provisional application No. 62/966,279, filed on Jan. 27, 2020.

(51) Int. Cl. G01B 9/02091

(52) U.S. Cl. CPC G01B 9/02091

(57) ABSTRACT

There is described a multimode interferometric device and a method for performing multimode interferometry. The device comprises at least one single-mode transmission input connectable to a light source for receiving single-mode light, a multimode output for emitting multimode light and collecting reflected multimode light, at least one photonic lantern operatively connected between the at least one single-mode transmission input and the multimode output and designed for converting the single-mode light into multimode light and converting the reflected multimode light into single-mode light, at least one single-mode reference input for generating at least one interference pattern between the reflected single-mode light and at least one single-mode reference signal, and at least one single-mode output connectable to a photodetector for detecting the at least one interference pattern.

### CROSS-REFERENCE TO RELATED APPLICATIONS

The present application claims the benefit of U.S. Provisional patent application No. 62/966,279 filed on Jan. 27, 2020, the contents of which are hereby incorporated by reference in their entirety.

### TECHNICAL FIELD

The present disclosure relates generally to interferometry and more particularly to fiber-based multimode interferometry.

### BACKGROUND OF THE ART

Interferometers are used in many fields of science. They come in various shapes and sizes, and have a wide array of applications, particularly in the domain of imaging and sensing. The basic principle of an interferometer is to create an interference pattern by merging two or more waves. Information may be extracted from the interference pattern. While the waves may be radio or sound waves, light waves have been found to be a valuable measurement technique as laser technology has evolved.

Optical coherence tomography (OCT) is one example of an imaging technique that relies on low coherence interferometry, for example to image biological tissues. This imaging technique can be used, inter alia, to image superficial brain structures.

Therefore, any improvements provided to the quality of the imaging are desirable.

### SUMMARY

In accordance with a broad aspect, there is provided a multimode interferometric device. The device comprises at least one single-mode transmission input connectable to a light source for receiving single-mode light, a multimode output for emitting multimode light and collecting reflected multimode light, at least one photonic lantern operatively connected between the at least one single-mode transmission input and the multimode output and designed for converting the single-mode light into multimode light and converting the reflected multimode light into single-mode light, at least one single-mode reference input for generating at least one interference pattern between the reflected single-mode light and at least one single-mode reference signal, and at least one single-mode output connectable to a photodetector for detecting the at least one interference pattern.

In an embodiment according to any of the previous embodiments, the at least one single-mode transmission input comprises a plurality of single-mode transmission inputs.

In an embodiment according to any of the previous embodiments, the plurality of single-mode transmission inputs comprises N single-mode transmission inputs, the at least one single-mode reference input comprises N single-mode reference inputs, and the at least one single-mode output comprises N single-mode outputs.

In an embodiment according to any of the previous embodiments, the device further comprises a plurality of power-splitting couplers connected between corresponding ones of the N single-mode transmission inputs, N single-mode reference inputs, and N single-mode outputs.

In an embodiment according to any of the previous embodiments, the plurality of single-mode transmission inputs comprises N single-mode transmission inputs, the at least one single-mode reference input comprises N single-mode reference inputs, and the at least one single-mode output comprises 2*N single-mode outputs.

In an embodiment according to any of the previous embodiments, the device further comprises N optical circulators connected between the N single-mode transmission inputs, the photonic lantern, and pairs of the 2N single-mode outputs, and N power-splitting couplers connected between the N single-mode reference inputs, the N optical circulators, and the pairs of the 2N single-mode outputs.

In an embodiment according to any of the previous embodiments, the at least one single-mode transmission input comprises one single-mode transmission input, the at least one single-mode reference input comprises one single-mode reference input, and the at least one single-mode output comprises a plurality of single-mode outputs, and further comprising a plurality of power splitting couplers arranged to interconnect the inputs and outputs for emitting at the multimode output in a single-mode Mo and collecting at the multimode output in any one of modes Mi depending on what mode is induced by the at least one single-mode reference signal.

In an embodiment according to any of the previous embodiments, the at least one single-mode transmission input comprises one single-mode transmission input, the at least one single-mode reference input comprises one single-mode reference input, and the at least one single-mode output comprises a plurality of single-mode outputs, and further comprising a plurality of power splitting couplers and optical circulators arranged to interconnect the inputs and outputs for light projecting and collecting using a linear combination of modes.

In an embodiment according to any of the previous embodiments, the device further comprises a reflection circuit connected to the at least one single-mode reference input to generate the at least one single-mode reference signal.

In accordance with another broad aspect, there is provided an imaging system comprising an imaging setup and at least one multimode interferometric device in an embodiment according to any of the previous embodiments. In an embodiment, the imaging setup is an optical coherence tomography (OCT) imaging setup.

In accordance with another broad aspect, there is provided a method for performing multimode interferometry. The method comprises receiving single-mode light at one or more single-mode transmission input of a multimode interferometric device, converting the single-mode light into multimode light and outputting the multimode light at a multimode output of the device, collecting reflected multimode light at the multimode output, converting the reflected multimode light into reflected single-mode light, obtaining at least one single-mode reference signal at one or more single-mode reference input of the device, generating interference patterns between the reflected single-mode light and the at least one single-mode reference signal, and detecting the interference patterns at one or more single-mode output of the device.

In an embodiment according to any of the previous embodiments, converting the single-mode light into multimode light and converting the reflected multimode light into reflected single-mode light comprises using a photonic lantern.

In an embodiment according to any of the previous embodiments, receiving single-mode light at one or more single-mode transmission input comprises receiving the single-mode light at a plurality of single-mode transmission inputs.

In an embodiment according to any of the previous embodiments, receiving the single-mode light comprises receiving the single-mode light at N single-mode transmission inputs; obtaining at least one single-mode reference signal comprises obtaining N single-mode reference signals; and detecting the interference patterns comprises detecting the interference patterns at N single-mode outputs.

In an embodiment according to any of the previous embodiments, receiving the single-mode light comprises receiving the single-mode light at N single-mode transmission inputs; obtaining at least one single-mode reference signal comprises obtaining N single-mode reference signals; and detecting the interference patterns comprises detecting the interference patterns at 2N single-mode outputs.

In an embodiment according to any of the previous embodiments, outputting the multimode light at the multimode output of the device comprises emitting the multimode light in a single-mode Mₒ, and wherein collecting the reflected multimode light comprises collecting at the multimode output in any one of modes Mᵢ depending on what mode is induced by the at least one reference signal.

In an embodiment according to any of the previous embodiments, outputting the multimode light and collecting the reflected multimode light at the multimode output comprises outputting and collecting using a linear combination of modes.

In an embodiment according to any of the previous embodiments, obtaining the at least one single-mode reference signal comprises receiving the least one single-mode reference signal from an external light source.

In an embodiment according to any of the previous embodiments, obtaining the at least one single-mode reference signal comprises creating the at least one single-mode reference signal from the single-mode light received at the at least one single-mode transmission input.

Features of the systems, devices, and methods described herein may be used in various combinations, in accordance with the embodiments described herein. In particular, any of the above features may be used together, in any combination.

### BRIEF DESCRIPTION OF THE DRAWINGS

Reference is now made to the accompanying figures in which:

FIG. 1 is a schematic diagram of an example multimode interferometric device;

FIGS. 2A and 2B illustrate an example photonic lantern;

FIG. 3 is a first example embodiment of the multimode interferometric device;

FIG. 4 is a second example embodiment of the multimode interferometric device;

FIG. 5 is a third example embodiment of the multimode interferometric device;

FIG. 6 is a fourth example embodiment of the multimode interferometric device;

FIG. 7 is an example embodiment of an imaging setup with the photonic lantern of FIGS. 2A, 2B;

FIG. 8 illustrates far-field intensity profiles of a few mode fiber showing LP₀₁ (top) and LP₁₁₊ (bottom);

FIG. 9 is a graphical representation of theoretical and experimental coupling efficiencies of LP₀₁ and LP₁₁₊;

FIGS. 10A-10H are examples of images obtained using the setup of FIG. 7; and

FIG. 11 is a flowchart of a method for performing multimode interferometry.

It will be noted that throughout the appended drawings, like features are identified by like reference numerals.

### DETAILED DESCRIPTION

There is described herein a multimode interferometric device and method of operating same. The device is configured for detecting an interference pattern between a reference mode and any mode of a multimode output. The device may be integrated or coupled to an imaging system, such as an imaging system for optical coherence tomography (OCT), spectroscopy, microscopy, super-resolution imaging (i.e. imaging that breaks the diffraction limit), adaptive optics imaging, Light Detection and Ranging (LIDAR) sensing, and other light-based imaging techniques. The imaging system may be for coherent or non-coherent light. In some embodiments, the multimode interferometric device is used for BRight field And Dark field (BRAD) OCT.

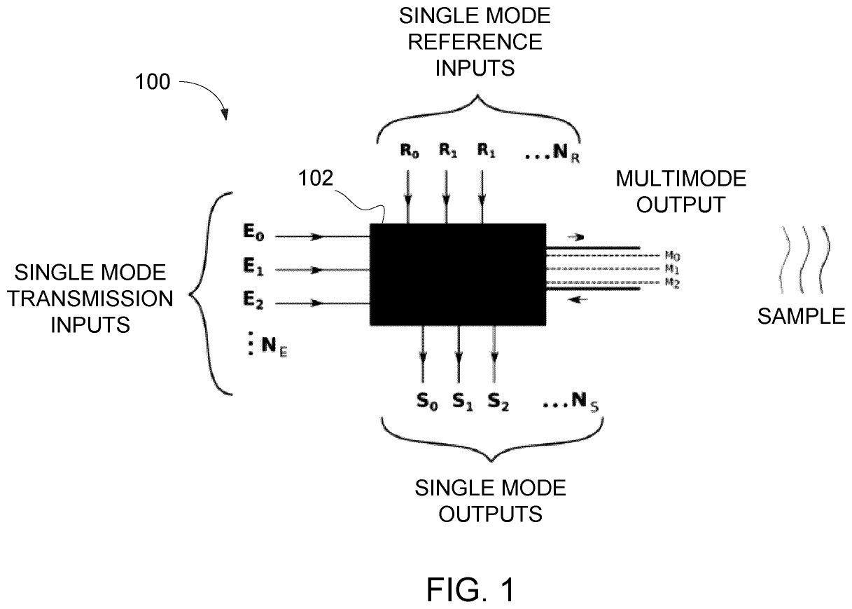

FIG. 1 illustrates an example embodiment of the multimode interferometric device 100. A waveguide 102 comprises a plurality of single-mode transmission inputs (E₀, E₁, E₂, . . . , N_{E}) that are each connectable to a light source, such as a laser. In use, the single-mode transmission inputs (E₀, E₁, E₂, . . . , N_{E}) may be connected to single-mode fibers (SMFs).

A multimode output emits light from the waveguide 102 to a sample and collects light reflected from the sample. Note that an optical imaging system may be provided between the multimode output of the device 100 and the sample. A plurality of modes (M₀, M₁, M₂) may be propagated in the multimode output. In some embodiments, the multimode output is connected to a few mode fiber (FMF), which may be coupled to an imaging head of an imaging system to emit and collect light.

A plurality of single-mode reference inputs (R₀, R₁, R₂, . . . , N_{R}) may be used for creating interference with a mode propagating in the multimode output. A plurality of single-mode outputs (S₀, S₁, S₂, . . . , N_{S}) are each connectable to a photodetector for detecting the interference. In some embodiments, the number of single-mode outputs corresponds to the number of single-mode transmission inputs and to the number of single-mode reference inputs. Alternatively, the number of single-mode outputs may differ from the number of single-mode transmission inputs and/or from the number of single-mode reference inputs.

The device 100 allows a plurality of reference modes to be used concurrently (with controlled relative phases) and allows for various combinations of modes at the output, for example in order to perform super-resolution imaging. Interferometric devices are usually based on a single-mode of emission and collection. However, device 100 may be used to perform interferometry on multiple modes in parallel without any significant impact on each individual interference pattern. Useful information may be retrieved using the first propagation modes of the multimode output by separating and measuring the interference patterns of the propagation modes separately and independently.

The waveguide 102 comprises at least one photonic lantern. A photonic lantern is understood to be a non-coupling fiber coupler that adiabatically merges several single-mode waveguides into one multimode waveguide. The photonic lantern has little or no crosstalk and is ideal for mode control. It provides a low-loss interface between single-mode and multimode for a large bandwidth (ex. 100 nm) and allows parallel measurement and control on mode propagation.

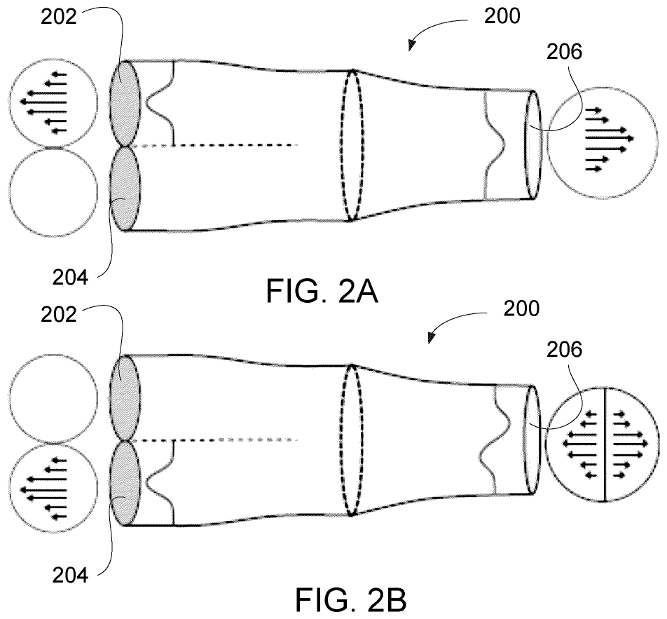

An example embodiment of a photonic lantern 200 is illustrated in FIGS. 2A and 2B. An achromatic two-to-one optical component consisting of two fused SMFs is shown. In FIG. 2A, the photonic lantern 200 converts the fundamental mode of the top fiber (input 202) into the LP₀₁ mode of the FMF (output 206). In FIG. 2B, the photonic lantern 200 converts the fundamental mode of the bottom fiber (input 204) into the mode of the FMF (output 206). The photonic lantern 200 thus acts as a multiplexor by exciting a given propagation mode in the multimode output 206 using a given one of the single-mode inputs 202, 204. The photonic lantern 200 also acts as a de-multiplexor in the reverse direction, when light is collected at the multimode output 206 and a corresponding single-mode input 202, 204 is excited.

The principle of operation for the example of FIGS. 2A, 2B may be defined mathematically as follows:

Σᵢaᵢ|LP₀₁ⁱ>↔Σᵢaᵢ|LPᵢ> (1)

The |LP₀₁ⁱ> state represents the fundamental mode of the i^{th} single-mode fiber, i.e. inputs 202 and 204 in the example of FIGS. 2A and 2B. The |LPᵢ> state represents the i^{th} solution of the multimode structure, i.e. output 206 in the example of FIGS. 2A and 2B. The complex coefficient aᵢ characterizes the basis change between the |LP₀₁ⁱ> state and the |LP i>state. In other words, a one-to-one mapping is performed between the single-mode fiber basis and the multimode fiber basis.

It will be understood that the example of FIGS. 2A, 2B are merely for illustration purposes and that various other embodiments may be used for the photonic lantern 200. In some embodiments, the photonic lantern is implemented using the embodiments described in International Patent Application Publication No. WO 2019/148276. Generally, any non-coupling fiber coupler (i.e. null coupler) that adiabatically merges several single-mode waveguides into one multimode waveguide and is designed in accordance with the desired characteristics of the multimode interferometric device 100 may be used.

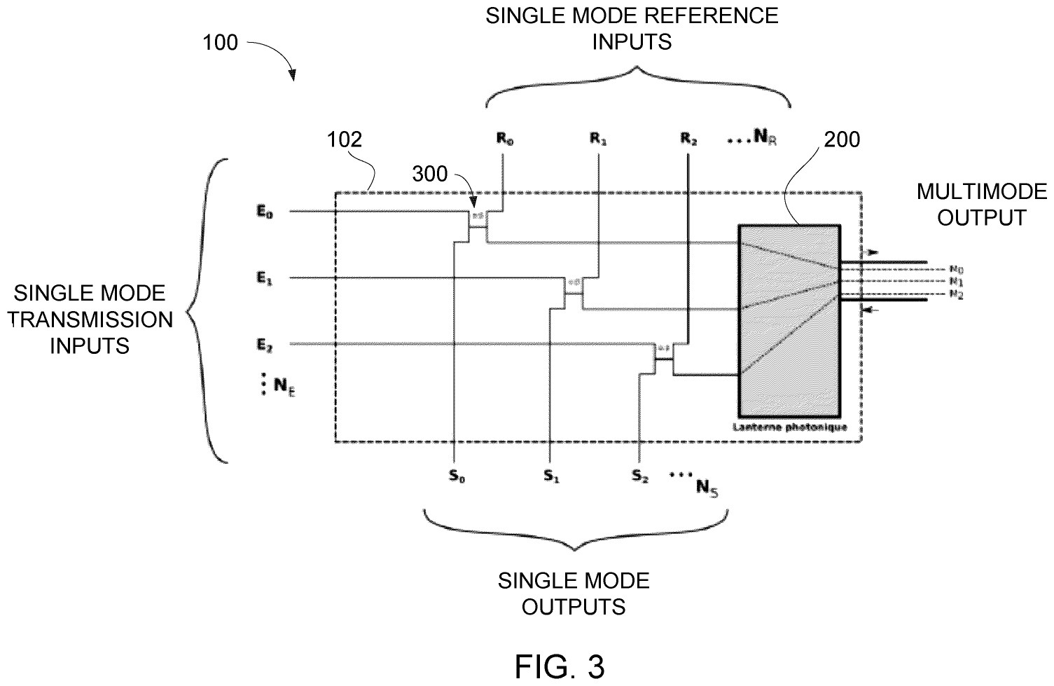

The multimode interferometric device 100 may be implemented in various manners. A first example embodiment is illustrated in FIG. 3. In this example, the number of single-mode outputs (S₀, S₁, S₂, . . . , N_{S}) corresponds to the number of single-mode transmission inputs (E₀, E₁, E₂, . . . , N_{E}) and to the number of single-mode reference inputs (R₀, R₁, R₂, . . . , N_{R}), i.e. N_{E}=N_{R}=N_{S}=N. A photonic lantern 200 and N power splitting couplers 300 are used to interconnect the single-mode transmission inputs, single-mode reference inputs, single-mode outputs, and the multimode output. An input signal Eᵢ is separated into two signals by a power splitting coupler 300 and coupled to a mode Mᵢ of the multimode output via the photonic lantern 200. The photonic lantern 200 performs a conversion from the N single-mode inputs to the multimode output having N modes.

The embodiment of FIG. 3 may be used, for example, to design a multimode OCT imaging system. In order to do so, the power splitting couplers 300 and the photonic lantern 200 should be wavelength independent. An ideal wavelength independent lantern produces the same one-to-one mapping for each wavelength. This means that the lantern is adiabatic for each wavelength and that the single-mode basis and the multimode basis are also the same for each wavelength.

As used herein, linearly polarised modes are denoted as {SLPᵢₘ}. When the waveguide 102 has the symmetry of a cylinder, the notation used is {LPᵢₘ}. In order to implement the device 100 in OCT, the signal of each input Eᵢ is propagated in the LP₀₁ mode until the photonic lantern 200, where it is converted into SLP₀₁ before interacting with the sample. The Mᵢ modes thus act as the base of the SLP modes at the multimode output.

When reflected light is collected at the multimode output, the photonic lantern 200 reconverts from the SLP basis towards the LP basis. The i^{th} coupler 300 combines a signal from Rᵢ with the signal coming from mode Mᵢ returned by the photonic lantern 200. The interference pattern is detected at output Sᵢ.

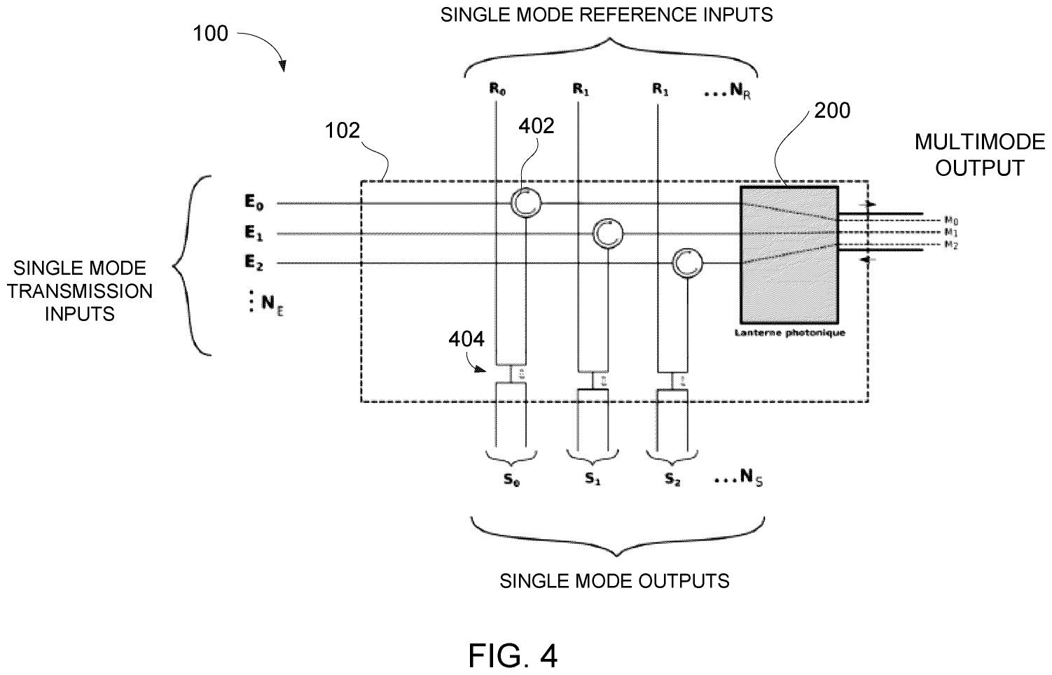

With reference to FIG. 4, another embodiment is provided for the multimode interferometric device 100. In this example, 2N_{E}=2N_{R}=N_{S}=2N. In other words, there are half as many single-mode transmission inputs (E₀, E₁, E₂, . . . , N_{E}) and single-mode reference inputs (R₀, R₁, R₂, . . . , N_{R}) as there are single-mode outputs (S₀, S₁, S₂, . . . , N_{S}). N optical circulators 402 and N power splitting couplers 404 are used in this implementation. The optical circulators 402 are wavelength independent and are connected between a single-mode transmission input Eᵢ and a power splitting coupler 404. The power splitting coupler 404 is connected between a single-mode reference input Rᵢ, the optical circulator 402, and a pair of single-mode outputs Sᵢ. The photonic lantern 200 is used in the same manner as that described with regards to the embodiment of FIG. 3. The single-mode outputs, of which there are 2N, are grouped into N pairs, each pair having two interference pattern signals.

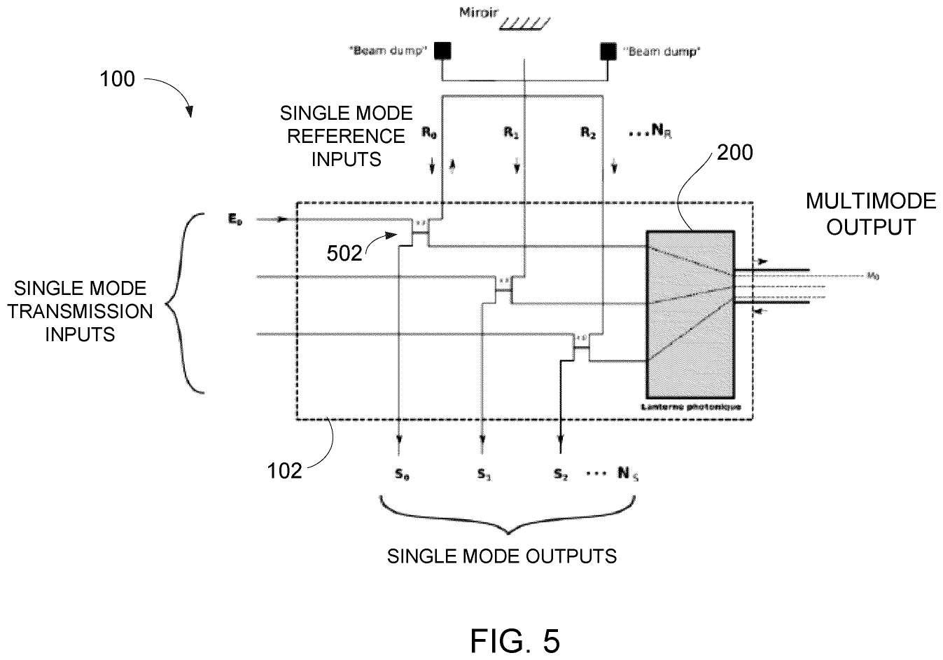

With reference to FIG. 5, yet another embodiment is provided for the multimode interferometric device 100. In this example, N_{E}=1; N_{R}=N_{S}=N. In other words, one single-mode transmission input (E₀, E₁, E₂, . . . , N_{E}), N single-mode reference inputs (R₀, R₁, R₂, . . . , N_{R}), and N single-mode outputs (S₀, S₁, S₂, . . . , N_{S}) are provided. All reference signals Rᵢ are created from a single input source, provided at input E₀. More generally, a reflection circuit may be connected to the single-mode reference inputs in order to create the interference pattern. The reflection circuit may include, for example, a mirror and one or more device for absorbing the energy of photons or other particles within an energetic beam (i.e. a beam dump, beam block, beam stop, or beam trap).

Light emitted at the multimode output and reflected on the sample is only in mode M₀, while light collected at the multimode output may be in any one of modes Mᵢ, depending on what mode is induced by the reflection of the light on the sample. The source may be moved to other ones of the single-mode transmission inputs Eᵢ in order to cause interference between the modes Mᵢ induced by reflection of the light on the sample, thus creating a coupling matrix. Such a matrix has a complex coefficient that characterises the coupling induced by the sample between modes Mᵢ and the multimode structure. In OCT imaging, an arrangement of lenses and mirrors may be inserted between the device 100 and the sample.

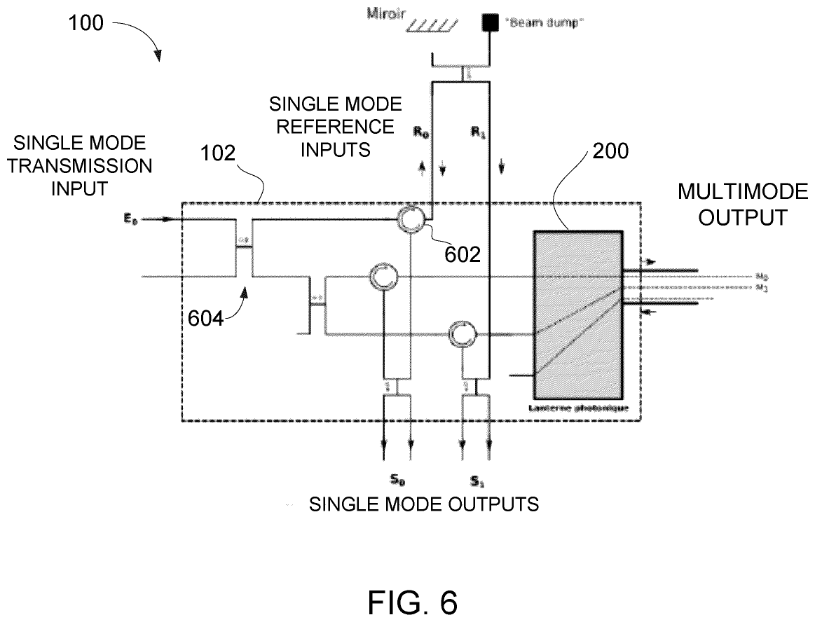

With reference to FIG. 6, another embodiment is provided for the multimode interferometric device 100. In this example, N_{E}=1; N_{R}=1; N_{S}=4. In other words, one single-mode transmission input (E₀, E₁, E₂, . . . , N_{E}), one single-mode reference input (R₀, R₁, R₂, . . . , N_{R}), and four single-mode outputs (S₀, S₁, S₂, . . . , N_{S}) are provided. This embodiment is an example of light projecting and collecting using a linear combination of modes. For example, modes M₀ and M₁ are linearly combined at the multimode output. The amplitude coefficients of this combination are dependent on the properties of power splitting couplers 604 inside the waveguide 102, and the phase coefficients of the combination are dependent on the length of the optical paths between the inputs and the outputs. Optical circulators 602 are also used in this arrangement, in addition to power splitting couplers 604. Note that certain details of this implementation have been omitted for simplicity, in order to illustrate the basic principle of operation of the device 100.

The embodiment of FIG. 6 may be used to perform super-resolution OCT imaging, i.e. OCT imaging where the resolution limit is lower than the conventional limit imposed by the diffraction of the imaging mode (in this case M₀).

It will be understood that the examples illustrated in FIGS. 3-6 are specific and non-limiting embodiments and that many other variants may be used. For example, in some embodiments, the single-mode reference inputs may be conceived to have a common global phase. Moreover, the single-mode reference inputs (R₀, R₁, R₂, . . . , N_{R}) may be generated using an external source, such as a laser, or an internal source, as shown in the example of FIG. 6.

The multimode interferometric device 100 may be used to provide a desired illumination using a mode selected from a plurality of available modes. A linear combination of modes may be excited, as selected by a user. The linear combination may then be provided as input to an imaging system in order to excite a sample. This is done, for example, in super-resolution imaging. The phase and amplitude of each mode guided back through the multimode output as collected from the sample may be determined.

Light is propagated from a plurality of single-mode structures to a multimode structure, thus allowing a wide variety of interference patterns to be created and detected. The optical circuit found within the device 100 may be independently adapted for each mode (for emission and detection). Detection can occur in parallel on any selected mode, without causing any additional latency or loss of information.

Coupling between excitation modes and collection modes may be measured in parallel. The coupling coefficients may provide information on the sample. When used in an imaging system based on coherent light, coupling induced by the sample between the emitting modes and the collection modes may be measured. This coupling may be used as a source of contrast in a volumetric image, or to obtain information on the diffusion properties of the sample.

In some embodiments, the inputs and outputs of the device 100 are fully compatible with standard optical equipment, such as laser sources, optical fibers, photodetectors, and the like.

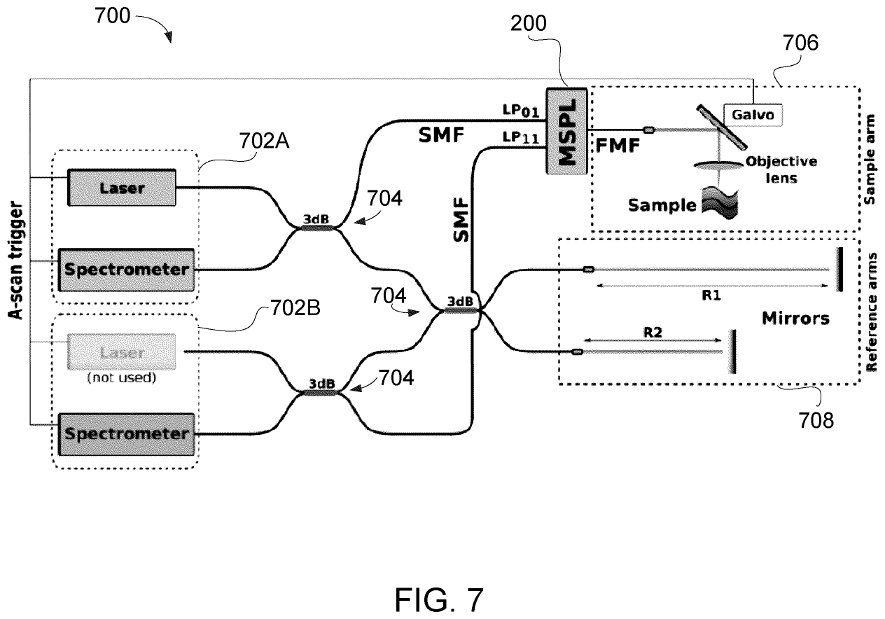

For testing purposes, the photonic lantern 200 illustrated in FIGS. 2A, 2B was incorporated into an imaging setup, as shown in FIG. 7. Two commercially available spectral domain OCT source/detector systems 702A, 702B were used (λ₀=930 nm, Δλ≈110 nm). The photonic lantern 200 was connected to the systems 702A, 702B via achromatic fiber couplers 704. A sample circuit 706 composed of various optical components represents a sample under observation. A reference circuit 708 composed of two individual reference arms is designed to compensate dispersion for each one of the two propagation modes of the setup 700.

Illumination carried out with a SMF through a lens results in the fundamental (and only) propagation mode (designated LP₀₁) on the sample, given that it is situated at the focal distance of the objective lens. Inversely, collecting light with an identical optical scheme leads to the projection of light returning from the sample into the fiber tip. As only the light that propagates through the collecting fiber is detected, it may be stated that only the light scattered by the sample that couples into the SMF, namely the LP₀₁ mode, is detected. The rest of the light couples to the cladding modes of the fiber, which are then lost in the first few centimeters of propagation. The intensity coupling efficiency of any two linearly polarized mode may be defined as:

$$η Ψ \to l , m = 〈 Ψ \vert {Φ}_{l , m} 〉 = \frac{{\vert \int {\int }_{S} Ψ ( x , y ) * Φ ( x , y ) dxdy \vert}^{2}}{\int {\int }_{S} {\vert Ψ ( x , y ) \vert}^{2} d x d y} \qquad ( 2 )$$

Here, |Ψ> represents the incident light state coming from the scatterers inside the sample and |ϕ_{l,m}> represents the fiber's LP_{l,m} modes. Measuring the relative intensities of each mode of the few-mode fiber equates to measuring the orthogonal projections of the scattering phase function of light returning from the sample. Given enough modes, and with knowledge of the illumination mode, the phase function of the backscattered light may be inferred.

For spherical dielectrics, the Mie scattering theory predicts that the scattering efficiency and phase function depend on the size parameter defined as: a=πd/λ, where d is the diameter of the spherical scatterer and λ is the wavelength of the incident light. As variations in the scattering phase function affect the coupling efficiencies of the different modes, measuring the ratio of these couplings would theoretically allow the geometry of the scatterer to be inferred, an information well below the resolution limit of an optical system. Efficient measurement of this mode-dependent coupling efficiency may thus be performed using an all-fiber modally specific photonic lantern (MSPL), as illustrated in FIGS. 2A, 2B.

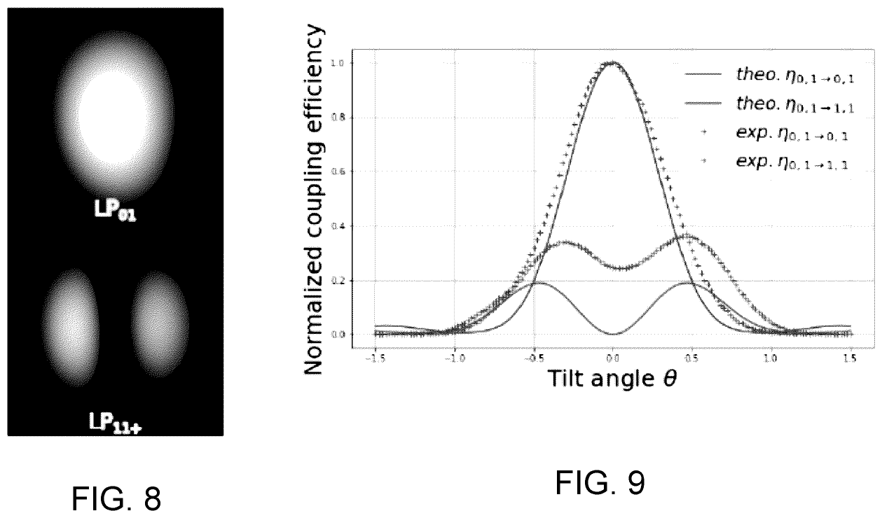

FIG. 8 shows the specificity of the modal multiplexing of the photonic lantern 200 as obtained using the setup 700, where each of the two modes of the FMF are individually excited. Validation of the demultiplexing scheme was performed using a tilted mirror instead of a sample and the mode coupling efficiency function of the tilt angle (θ) was measured while illuminating with the LP₀₁ mode. The tilt of the mirror results in a phase shift of the projected LP₀₁ mode alongside the tilt axis, causing the mode to couple with LP₁₁₊. Using equation (1), the coupling efficiencies can be written as:

$$\{ \begin{matrix}{η}_{0 , 1 \to 0 , 1} ( θ ) = 〈 {Φ}_{0 , 1} ( θ ) \vert {Φ}_{0 , 1} ( θ = 0 〉 \\ {η}_{0 , 1 \to 1 , 1} ( θ ) = 〈 {Φ}_{0 , 1} ( θ ) \vert {Φ}_{1 , 1} ( θ = 0 〉\end{matrix} \qquad ( 3 )$$

From the OCT A-lines and using Parseval's theorem (which asserts that the Fourier transform is unitary), the total intensity of the collected bandwidth for each tilt angle can be inferred from the Fourier transform of the interferometric signal of the OCT.

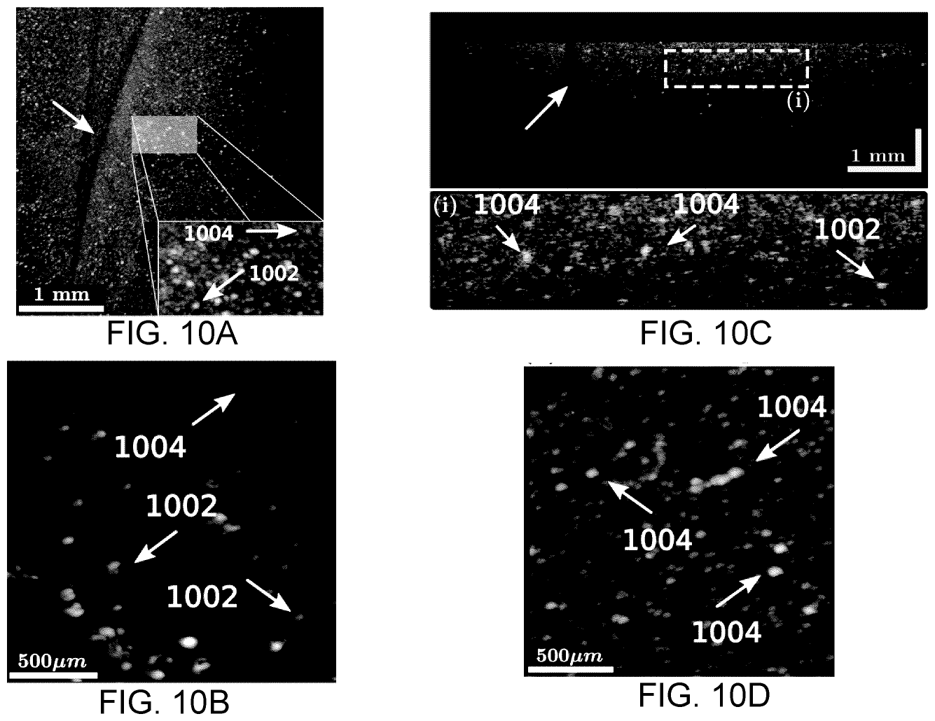

FIG. 9 shows theoretical and experimental coupling between the two modes. The accordance between the theory and experiment indicates that the apparatus demultiplexes the propagation modes according to the theory.

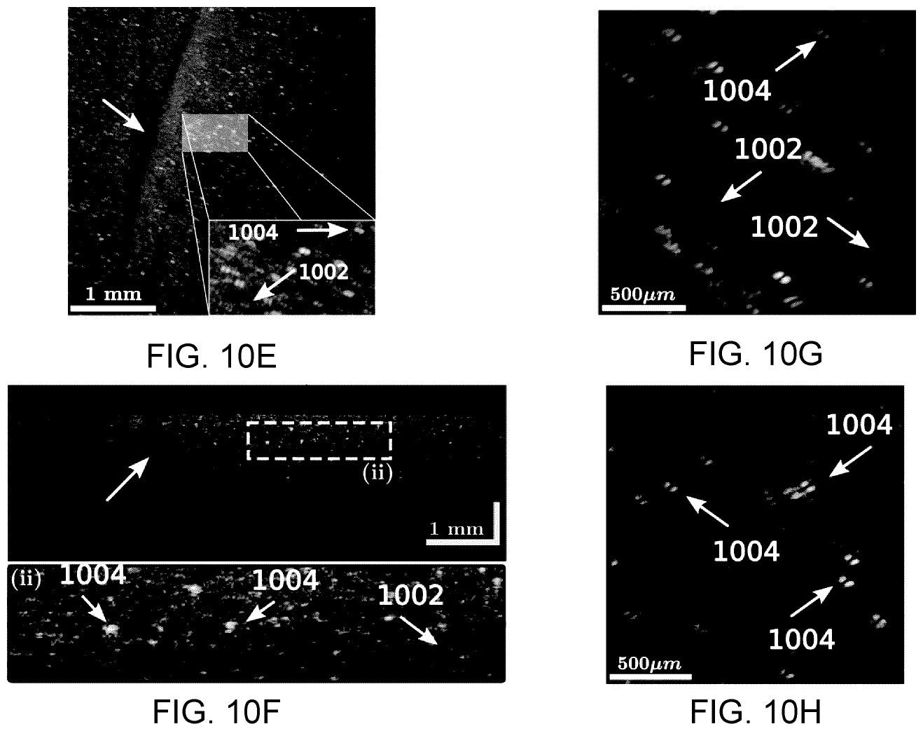

FIGS. 10A-10H show OCT images acquired using the setup 700 of FIG. 7. FIGS. 10A-10D are obtained using the LP₀₁ mode for illumination and LP₀₁ mode for collection and correspond to front facing (FIG. 10A), B-scan (FIG. 10B), Dispersed (FIG. 10C), and standard size and dispersed (FIG. 10D) views. FIGS. 10E-10H are obtained using the LP₀₁ mode for illumination and mode for collection, and correspond to front facing (FIG. 10E), B-scan (FIG. 10F), Dispersed (FIG. 10G), and standard size and dispersed (FIG. 10H) views. The sample was an optical phantom composed of infrared-transparent Polydimethylsiloxane (PDMS) and TiO₂ micro-beads. Arrows 1002 highlight a stronger LP₀₁ contrast, while arrows 1004 highlight a stronger contrast. These images demonstrate a visible contrast between light collected from the first two modes of an FMF, using an all-fiber system based on a photonic lantern 200. This contrast based on particle geometry allows additional information to be inferred, the additional information being below the imaging resolution and otherwise inaccessible. Other permutations of illumination or collection modes in the |LPᵢ> may also be used, leading to a wide range of possible applications.

Although the photonic lantern 200 of FIGS. 2A, 2B has two modes, it will be understood that more modes may be provided. In addition to more contrast channels, more modes may also provide more information on directional scattering as expected for cylindrical-like shaped cells, such as muscle cells. In some embodiments, the photonic lantern 200 may be used to excite each individual mode in order to study the response of samples to illumination with non-fundamental modes.

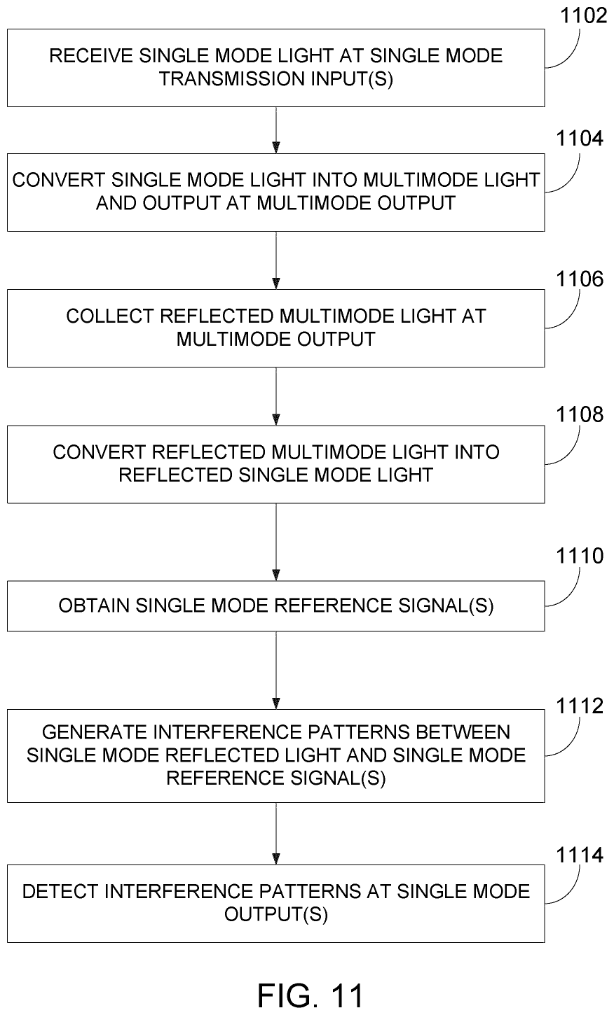

In accordance with the above, there is described herein a method for performing multimode interferometry, as illustrated in the flowchart of FIG. 11. At step 1102, single-mode light is received at one or more of a plurality of single-mode transmission inputs of a multimode interferometric device, such as device 100. Depending on the characteristics of the device, single-mode light may be received at a single input (see examples of FIGS. 5 and 6) or at multiple inputs (see examples of FIGS. 3 and 4). Light may be coupled into the device using one or more light source.

At step 1104, the single-mode light is converted into multimode light and output at the multimode output of the device. One or more photonic lantern, for example photonic lantern 200, may be used for this conversion. When light is received at multiple single-mode transmission inputs, the single-mode light of each input may be converted into the multimode light. The photonic lantern multiplexes the single-mode light into the multimode output.

At step 1106, reflected multimode light is collected at the multimode output. The reflected multimode light may be reflected, for example, from a biological sample. In some embodiments, the reflected multimode light is received through one or more additional optical components, for example from an imaging system.

At step 1108, the reflected multimode light is converted into reflected single-mode light. One or more photonic lantern may be used for this conversion. The photonic lantern demultiplexes the reflected multimode light into the reflected single-mode light.

At step 1110, at least one single-mode reference signal is obtained at one or more single-mode reference input. In some embodiments, the single-mode reference signal(s) is received from one or more external light source. In some embodiments, the single-mode reference signal(s) is created from the single-mode light received at the one or more single-mode transmission inputs.

At step 1112, interference patterns are generated between the single-mode reflected light and the single-mode reference signal(s). At step 1114, the interference patterns are detected at one or more single-mode outputs of the device.

The method of FIG. 11 is applicable to all of the embodiments of the multimode interferometric device 100 described herein. In some embodiments, the method is performed within the context of an imaging system, for example OCT imaging or super-resolution imaging. Other embodiments may also apply.

The above description is meant to be exemplary only, and one skilled in the art will recognize that changes may be made to the embodiments described without departing from the scope of the invention disclosed. For example, step 1110 may be performed at any time during the method, not only after the reflected multimode light is collected and converted into reflected single-mode light. Other variants may also be made to the order of the steps of the method of FIG. 11. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A multimode interferometric device comprising:
at least one single-mode transmission input connectable to a light source for receiving single-mode light;
a multimode output for emitting multimode light and collecting reflected multimode light;
at least one photonic lantern operatively connected between the at least one single-mode transmission input and the multimode output and designed for converting the single-mode light into multimode light and converting the reflected multimode light into single-mode light;
at least one single-mode reference input for generating at least one interference pattern between the reflected single-mode light and at least one single-mode reference signal; and
at least one single-mode output connectable to a photodetector for detecting the at least one interference pattern.

2. The device of claim 1, wherein the at least one single-mode transmission input comprises a plurality of single-mode transmission inputs.

3. The device of claim 2, wherein the plurality of single-mode transmission inputs comprises N single-mode transmission inputs, the at least one single-mode reference input comprises N single-mode reference inputs, and the at least one single-mode output comprises N single-mode outputs.

4. The device of claim 3, further comprising a plurality of power-splitting couplers connected between corresponding ones of the N single-mode transmission inputs, N single-mode reference inputs, and N single-mode outputs.

5. The device of claim 2, wherein the plurality of single-mode transmission inputs comprises N single-mode transmission inputs, the at least one single-mode reference input comprises N single-mode reference inputs, and the at least one single-mode output comprises 2*N single-mode outputs.

6. The device of claim 5, further comprising:
N optical circulators connected between the N single-mode transmission inputs, the photonic lantern, and pairs of the 2N single-mode outputs; and
N power-splitting couplers connected between the N single-mode reference inputs, the N optical circulators, and the pairs of the 2N single-mode outputs.

7. The device of claim 1, wherein the at least one single-mode transmission input comprises one single-mode transmission input, the at least one single-mode reference input comprises one single-mode reference input, and the at least one single-mode output comprises a plurality of single-mode outputs, and further comprising a plurality of power splitting couplers arranged to interconnect the inputs and outputs for emitting at the multimode output in a single-mode M₀ and collecting at the multimode output in any one of modes Mᵢ depending on what mode is induced by the at least one single-mode reference signal.

8. The device of claim 1, wherein the at least one single-mode transmission input comprises one single-mode transmission input, the at least one single-mode reference input comprises one single-mode reference input, and the at least one single-mode output comprises a plurality of single-mode outputs, and further comprising a plurality of power splitting couplers and optical circulators arranged to interconnect the inputs and outputs for light projecting and collecting using a linear combination of modes.

9. The device of claim 1, further comprising a reflection circuit connected to the at least one single-mode reference input to generate the at least one single-mode reference signal.

10. An imaging system comprising:
an imaging setup; and
at least one multimode interferometric device as described in claim 1.

11. The imaging setup of claim 10, wherein the imaging setup is an optical coherence tomography (OCT) imaging setup.

12. A method for performing multimode interferometry, the method comprising:
receiving single-mode light at one or more single-mode transmission input of a multimode interferometric device;
converting the single-mode light into multimode light and outputting the multimode light at a multimode output of the device;
collecting reflected multimode light at the multimode output;
converting the reflected multimode light into reflected single-mode light;
obtaining at least one single-mode reference signal at one or more single-mode reference input of the device;
generating interference patterns between the reflected single-mode light and the at least one single-mode reference signal; and
detecting the interference patterns at one or more single-mode output of the device.

13. The method of claim 9, wherein converting the single-mode light into multimode light and converting the reflected multimode light into reflected single-mode light comprises using a photonic lantern.

14. The method of claim 12, wherein receiving single-mode light at one or more single-mode transmission input comprises receiving the single-mode light at a plurality of single-mode transmission inputs.

15. The method of claim 14, wherein:
receiving the single-mode light comprises receiving the single-mode light at N single-mode transmission inputs;
obtaining at least one single-mode reference signal comprises obtaining N single-mode reference signals; and
detecting the interference patterns comprises detecting the interference patterns at N single-mode outputs.

16. The method of claim 14, wherein:
receiving the single-mode light comprises receiving the single-mode light at N single-mode transmission inputs;
obtaining at least one single-mode reference signal comprises obtaining N single-mode reference signals; and
detecting the interference patterns comprises detecting the interference patterns at 2N single-mode outputs.

17. The method of claim 12, wherein outputting the multimode light at the multimode output of the device comprises emitting the multimode light in a single-mode M₀, and wherein collecting the reflected multimode light comprises collecting at the multimode output in any one of modes Mᵢ depending on what mode is induced by the at least one reference signal.

18. The method of claim 12, wherein outputting the multimode light and collecting the reflected multimode light at the multimode output comprises outputting and collecting using a linear combination of modes.

19. The method of claim 12, wherein obtaining the at least one single-mode reference signal comprises receiving the least one single-mode reference signal from an external light source.

20. The method of claim 12, wherein obtaining the at least one single-mode reference signal comprises creating the at least one single-mode reference signal from the single-mode light received at the at least one single-mode transmission input.
